(19) United States
(12) Patent Application Publication
(10) Pub. No.: US 2025/0134193 A1
(43) Pub. Date: May 1, 2025

(54) SURGICAL GLOVES HAVING NESTING REGIONS

(71) Applicant: Summit Glove Inc., Minerva, OH (US)

(72) Inventor: James L. HULL, Malvern, OH (US)

(73) Assignee: Summit Glove Inc., Minerva, OH (US)

(21) Appl. No.: 18/497,023

(22) Filed: Oct. 30, 2023

(51) Int. Cl. A41D 19/015; A41D 31/10; A62B 17/00

(52) U.S. Cl. CPC A41D 19/015; A41D 31/10; A62B 17/006; A41D 2400/82

(57) ABSTRACT

A glove assembly including identically-configured first and second gloves which are pulled, one over the other, onto a person's hand. The first glove defines an interior cavity which receives the person's hand therein. When the second glove is pulled over the same hand that is covered by the first glove, the first glove is received within an interior cavity of the second glove. Gripping regions on the first and second gloves are complementary in configuration and are located so that when both gloves are pulled over the same hand, the gripping regions on the first and second gloves nest with one another. The glove assembly provides double protection to the person's hand and the nesting of the two gloves ensures tactile sensitivity and finger dexterity are maintained.

### TECHNICAL FIELD

This disclosure is directed to gloves. More particularly, this application is directed to surgical gloves, i.e., gloves used particularly by surgeons and other medical professionals. Specifically, the surgical gloves disclosed herein are designed for double-gloving, i.e., two gloves worn on a same hand, with one glove worn over the other, and where the gloves include physical profile features which nest or conform to one another when the gloves are worn one over the other.

### BACKGROUND ART

Surgeons wear protective gloves in order to protect themselves from pathogens and bodily fluids from the patient undergoing surgery or treatment. Not only do the gloves protect the surgeon, but they also protect the patient by helping to maintain a sterile environment during the surgery or treatment.

One of the issues surgeons face while working is that they may accidentally prick or cut themselves because they are using sharp implements. This could lead to the surgeon being directly exposed to harm from pathogens or bodily fluids. It is therefore not uncommon for surgeons to double-glove, i.e., wear one glove over another on both hands in order to place an additional protective barrier between their skin and the sharp implements. However, it is also vital for surgeons to maintain their tactile sensitivity and finger dexterity while performing surgery. In other words the surgeon needs to be able to feel what they are doing through their fingertips and they need to be able to readily and easily move their fingers and thumbs around. Double-gloving reduces tactile sensitivity and restricts the motion of fingers and thumbs.

Tactile sensitivity is reduced in two ways. Firstly, there are now two layers of glove material between the surgeon's fingertips and the outside environment. The increased thickness of the glove material reduces the ability of the fingertips to gather information from the environment. Secondly, there is a tendency for the outer glove to move relative to the inner glove. This can lead to surplus glove material gathering up at the fingertip region of the lower glove, thereby tending to increase the thickness of the glove material in this region even further, and thereby reducing tactile sensitivity even further.

Finger dexterity also tends to be reduced because of the increased thickness of the glove material about the entire exterior surface of the fingers and thumb. The increased thickness may cause the finger regions of the glove to contact and rub against one another to a greater degree. This can cause parts of the outer glove to twist around and pull on the glove material of other parts of the glove, limiting the movement of the surgeon's fingers.

### SUMMARY OF THE INVENTION

The glove of the present disclosure addresses some of the problems of the problems experienced with prior art surgical gloves. The configuration of the gloves is such that tactile sensitivity and finger dexterity is reduced to a lesser degree over prior art gloves when the glove of the present disclosure is worn as a double glove on a same hand. It will be understood that while the disclosed gloves are useful for medical practitioners such as surgeons, the disclosed glove assembly is useful in a wide variety of other professions and applications in which it is advisable or necessary to cover a person's hands with a glove.

A glove assembly in accordance with the present disclosure includes identically-configured first and second gloves which are pulled, one over the other, onto a person's hand. The first glove defines an interior cavity which receives the person's hand therein. When the second glove is pulled over the same hand that is covered by the first glove, the first glove is received within an interior cavity of the second glove. An exterior surface of the first glove nests within an interior surface of the second glove. In particular, profile features on the first and second gloves are complementary in configuration and are located so that when both gloves are pulled over the same hand, the profile features on the first and second gloves nest with one another. In one embodiment, gripping regions on the back of one or more of the digit regions of the first glove nest within one or more of the digit regions of the second glove. Additionally, reduced circumference fingertip regions on the first glove nest within reduced circumference fingertip regions of the second glove. The glove assembly provides double protection to the person's hand and the nesting capability of the two gloves ensures the person's tactile sensitivity and finger dexterity are substantially maintained.

In one aspect, an exemplary embodiment of the present disclosure may provide a glove assembly comprising a first glove and a second glove; wherein each of the first glove and the second glove includes a plurality of digit regions; a first gripping region provided on a back of at least one digit region of the plurality of digit regions of the first glove; a second gripping region provided on a back of at least one digit region of the plurality of digit regions of the second glove; wherein the second gripping region is complementary to the first gripping region; wherein the first glove defines an interior cavity adapted to receive a hand of a person therein; wherein the second glove defines an interior cavity; wherein the first glove is received within the interior cavity of the second glove; and wherein the first gripping region nests within the second gripping region when the first glove is received within the interior cavity of the second glove.

In one embodiment, the first gripping region comprises a plurality of undulations formed in the back surface of the one or more digit regions of the first glove, and the second gripping regions comprises a plurality of undulations formed in the back surface of the one or more digit regions of the second glove. In one embodiment, the plurality of undulations in each of the first glove and the second glove comprises a plurality of alternating peaks and valleys. In one embodiment, the peaks of the plurality of undulations in the first glove nest with the peaks of the plurality of undulations in the second glove. In one embodiment, the valleys of the plurality of undulations in the first glove nest with the valleys of the plurality of undulations in the second glove.

In one embodiment, each of the first gripping region and the second gripping region originates a distance inwardly from a tip of a digit region of a respective one of the first glove and the second glove. In one embodiment, each of the first gripping region and the second gripping region terminates a distance outwardly from a digit crotch of the respective one of the first glove and the second glove, wherein the digit crotch extends between two adjacent digit regions on the respective one of the first glove and the second glove. In one embodiment, the glove assembly further comprises a third glove and a fourth glove configured to be worn on an opposite hand of the person from the hand upon which the first glove and the second glove are worn; and wherein the third glove and fourth glove are identical to one another and are configured as mirror images of the first glove and the second glove.

In one embodiment, each of the first glove and the second glove includes a wrist region; a palm region extending outwardly from the wrist region; wherein the plurality of digit regions extend outwardly from a portion of the palm region opposite the wrist region; and wherein the wrist region, the palm region, and the plurality of digit regions together defines the interior cavity of a respective one of the first glove and the second glove. In one embodiment, the wrist region, the palm region, and the plurality of digit regions are fabricated from a glove material which is resistant to one or more of opioids, substances mixed with opioids, bodily fluids, and toxic or corrosive chemicals. In one embodiment, the wrist region, the palm region, and the plurality of digit regions are fabricated such that the interior surface of each of the first glove and the second glove is of a first color and the exterior surface of each of the first glove and the second glove is of a second color, and the first color contrasts with the second color. In one embodiment, providing the interior surface of the first color and the exterior surface of the second color acts as a wear or cut indicator.

In one embodiment, the one or more digit regions of the plurality of digit regions includes a fingertip region and a remaining portion, wherein the fingertip region is of a reduced circumference relative to a circumference of the remaining portion thereof.

In one embodiment, a transition portion extending between the fingertip region and the remaining portion, wherein the transition regions tapers in circumference moving in a direction away from the palm region and towards a tip of the one or more digit regions. In one embodiment, the fingertip region, the transition portion, and the remaining portion of the one or more digit regions of the first glove nest within the fingertip region, the transition portion, and the remaining portion of the one or more digit regions of the second glove. In one embodiment, the plurality of undulations originate and terminate in the remaining portion of the one or more digit regions, and wherein the plurality of undulations in the first glove nest within the plurality of undulations in the second glove.

In another aspect, an exemplary embodiment of the present disclosure may provide a method protecting a person's hand comprising providing a first glove and a second glove which are substantially identical in physical configuration; pulling the first glove over the person's hand; pulling the second glove over person's hand while covered with the first glove; receiving the first glove within an interior cavity of the second glove; and nesting a first gripping region provided on a back of at least one digit region of the first glove within a second gripping region provided on a back of at least one digit region of the second glove.

In one embodiment, the method further comprises forming the first gripping region as a plurality of alternating peaks and valleys in the back of the at least one digit region of the first glove; and forming the second gripping region as a plurality of alternating peaks and valleys in the back of the at least one digit region of the second glove. In one embodiment, nesting the first gripping region with the second gripping region includes nesting the peaks of the first gripping region with the peaks of the second gripping region; and nesting the valleys of the first gripping region with the valleys of the second gripping region. In one embodiment, the method further comprises forming the first glove and the second glove from a same glove material. In one embodiment, the method further comprises forming the first glove from a first material; and forming the second glove from a second material, wherein the second material is different from the first material.

### BRIEF DESCRIPTION OF THE DRAWINGS

Sample embodiments of the present disclosure are set forth in the following description, are shown in the drawings and are particularly and distinctly pointed out and set forth in the appended claims.

FIG. 1 is a diagrammatic first operational view showing a first glove and a second glove of a first embodiment of a double glove assembly in accordance with an aspect of the present disclosure, with the double glove assembly positioned for donning on a left hand of a user;

FIG. 2 is a diagrammatic second operational view showing the first glove of the double glove assembly of FIG. 1 donned on the left hand of the user; and showing the second glove of the double glove assembly positioned for donning on the left hand of the user over the first glove;

FIG. 3 is a diagrammatic third operational view showing the double glove assembly of FIG. 1 donned on the left hand of the user;

FIG. 4 is a front, right side, isometric perspective view of the first embodiment double glove assembly shown in isolation;

FIG. 5 is a front elevation view of the hand-specific double glove assembly of FIG. 4;

FIG. 6 is a rear elevation view of the hand-specific double glove assembly of FIG. 4;

FIG. 7 is a front, right side, isometric perspective view of the first embodiment double glove assembly shown in isolation;

FIG. 8 is a front elevation view of the hand-specific double glove assembly of FIG. 7;

FIG. 9 is a rear elevation view of the hand-specific double glove assembly of FIG. 7;

FIG. 10A is a longitudinal cross-section through the double glove assembly taken along and looking in the direction of line 10A-10A of FIG. 3, showing the double glove assembly in an initial donned condition on a person's hand and where a gripping region on the first glove and a gripping region on the second glove are not fully nested with one another;

FIG. 10B is a longitudinal cross-section through the double glove assembly on the person's hand similar to FIG. 10A, with the double glove assembly shown in a final donned condition and where the gripping regions of the first glove and the second glove are fully nested with one another and the double-glove assembly is ready for use;

FIG. 11A is an enlarged longitudinal cross-section through the middle finger regions of the double glove assembly as taken along and looking in the direction of 11A-11A of FIG. 9, with the middle finger of the user shown in a straight position;

FIG. 11B is an enlarged longitudinal cross-section through the middle finger regions similar to FIG. 11A showing the middle finger of the user in a bent position;

FIG. 12 is a front, right side, isometric perspective view of a second embodiment of a double glove assembly in accordance with the present disclosure;

FIG. 13 is a front elevation view of the hand-specific double glove assembly of FIG. 12;

FIG. 14 is a rear elevation view of the hand-specific double glove assembly of FIG. 12; and

FIG. 15 is an enlarged longitudinal cross-section through the middle finger regions of the glove of FIG. 12, similar to FIG. 11A, where the middle finger of the user is in the straight position.

Similar numbers refer to similar parts throughout the drawings.

### DETAILED DESCRIPTION

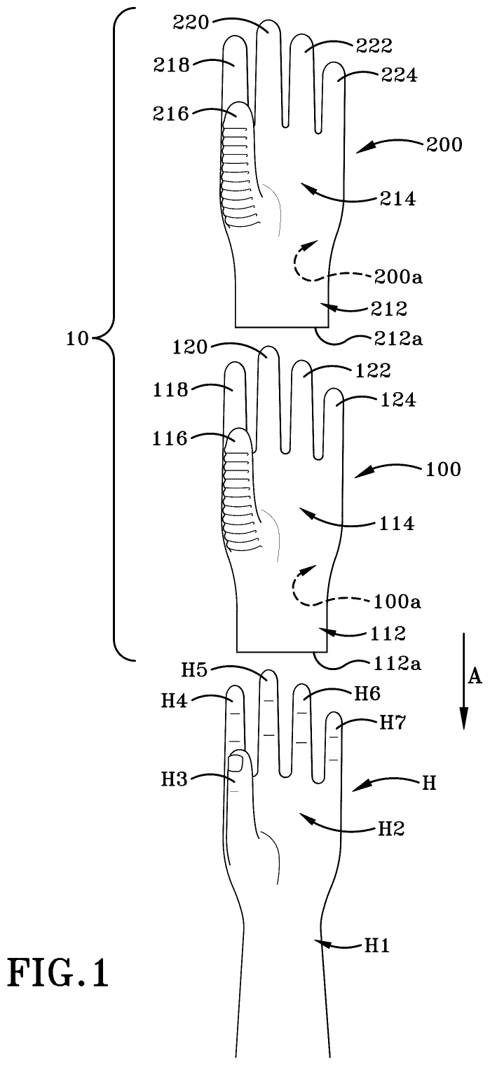

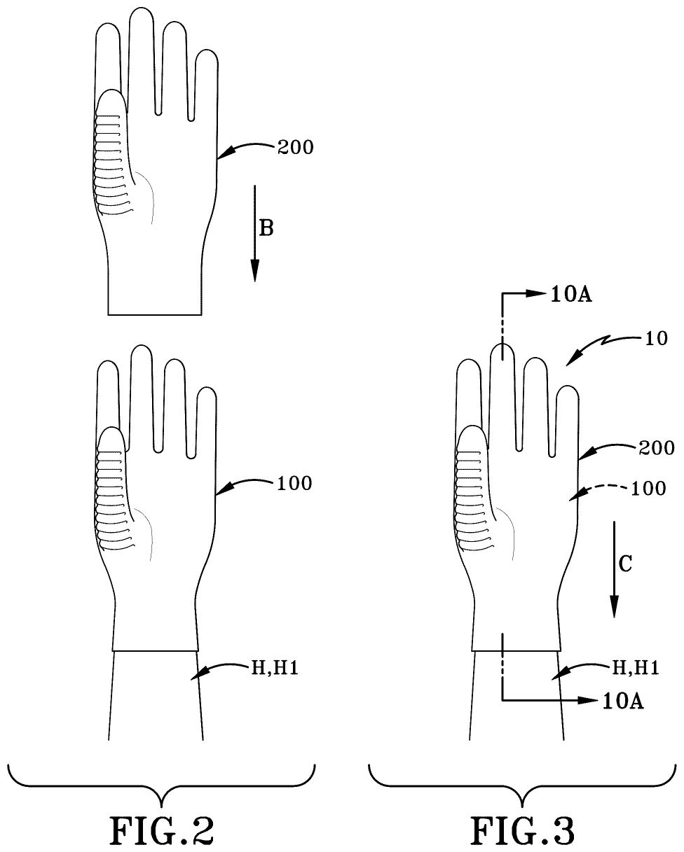

Referring to FIGS. 1-3, there is shown a first embodiment of half of a double glove assembly in accordance with the present disclosure, generally indicated at 10. The half of the double glove assembly 10 (hereafter referred to as “assembly 10”) illustrated in FIGS. 1-3 comprises a first glove 100 and a second glove 200 which are configured to both be donned on a same hand of a person. In particular, first glove 100 and second glove 200 are hand-specific gloves which are configured to both be donned on a person's left hand. It should be understood that in order for the person to perform a task while wearing a full double glove assembly 10, the person will need a glove kit comprising a first glove 100 and a second glove 200 for their left hand and a first glove and a second glove for their right hand. The half of the assembly 10 for the right hand will comprise a first glove and a second glove which are configured as mirror images of first glove 100 and second glove 200. It will be understood that the description hereafter of the first glove 100 and second glove 200 applies equally to the other half of the double glove assembly 10 configured for the person's right hand.

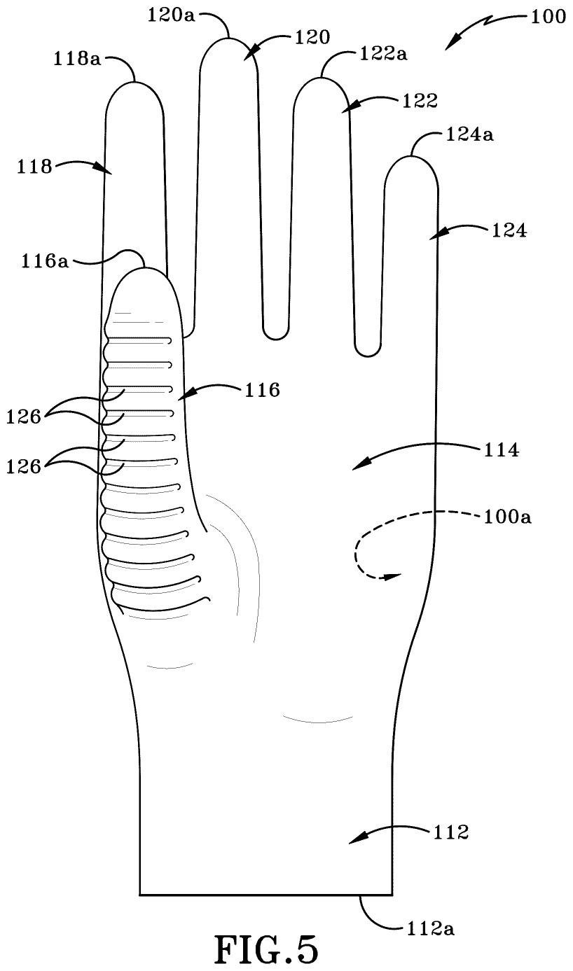

First glove 100 and second glove 200 are illustrated in greater detail in FIGS. 4 through 9 as being identical in all aspects relating to structure, function, and use, and are particularly configured for donning, one over the other, on a left hand “H” (FIG. 1) of a person. FIG. 1 shows the person's left hand “H” includes a wrist “H1”, a palm “H2”, a thumb “H3”, an index finger “H4”, a middle finger “H5”, a ring finger “H6”, and a little finger “H7”. Obviously, since the person's hand is three-dimensional in configuration, the wrist “H2” illustrated in FIG. 4 should be understood to encompass an entire exterior circumference of the user's wrist; the palm “H3” should be understood to encompass an exterior circumference of the user's palm, the back of their hand, and the sides therebetween, and the thumb “H3” and fingers “H4” through “H7” should be understood to encompass an exterior circumference of the user's thumb and fingers.

The first glove 100 and second glove 200 disclosed herein are comprised of any suitable glove material such as nitrile. The nitrile is free of or essentially free of zinc and/or sulfur and/or accelerators/accelerants. Some accelerators/accelerants that the glove's nitrile is free of or essentially free of may include carbonates or thiurams. In some embodiments, the first glove 100 and second glove 200 may be comprised of more than one layer and, in this instance, an inner layer of the glove which may contact the user's skin will be comprised of nitrile that is free of zinc, sulfur, and accelerators (accelerants). The composition of the glove material may tend to reduce hypersensitivity or allergic reactions in populations that are required to frequently wear protective gloves. First glove 100 and second glove 200 preferably are furthermore fabricated of nitrile which is resistant to toxic or corrosive substances. These substances include, but are not limited to, drugs mixed with opioids. The opioids with respect to which the glove material may be resistant include, but are not limited to, fentanyl, carfentanil, heroin (diacetylmorphine), morphine, oxycodone, buprenorphine, methadone, hydrocodone (dihydrocodeinone), meperidine, codeine, tramadol, and oxymorphone. The glove material is furthermore resistant to drugs such as xylazine, which is a non-opioid sedative or tranquilizer. The glove material is furthermore resistant to drugs such as xylazine mixed with an opioid. Still further, the glove material for use in first glove 100 and second glove 200 is resistant to bodily fluids such as gastric acid.

Referring now to FIGS. 4 to 6, first glove 100 comprises a wrist region 112, a palm region 114, a thumb region 116, an index finger region 118, a middle finger region 120, a ring finger region 122, and a little finger region 124. Thumb region 116, index finger region 118, middle finger region 120, ring finger region 122, and little finger region 124 will be collectively referred to hereinafter as “digit regions”. Wrist region 112, palm region 114, and digit regions 116, 118, 120, 122 124 bound and define a three-dimensional interior cavity 100a configured to receive the hand “H” of the person therein. Wrist region 112 defines an opening (not shown) bounded by an end 112a of wrist region 112.

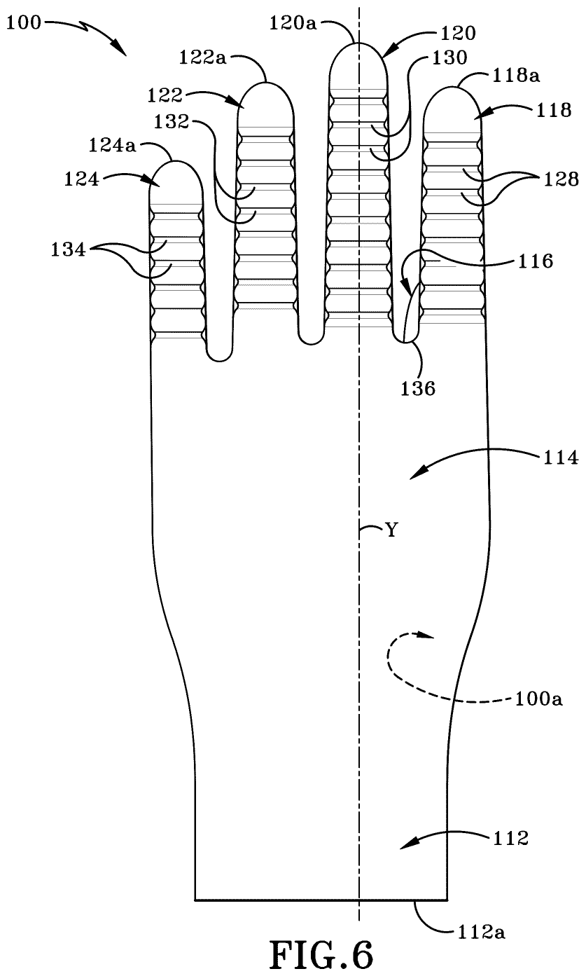

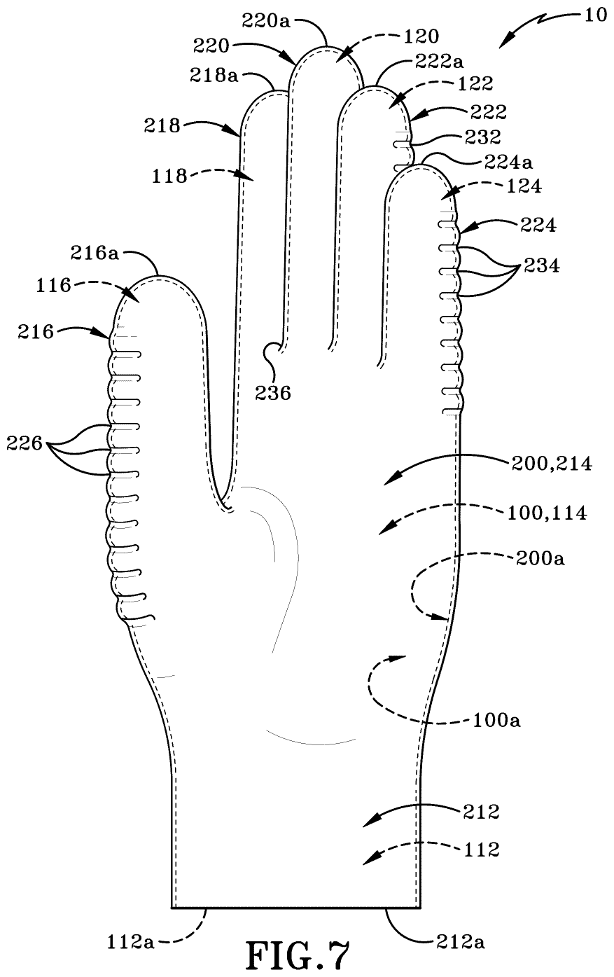

Referring to FIG. 5, the surfaces of first glove 100 facing the viewer of the figure may be considered to form a “front” of the first glove 100. Because FIG. 5 shows a “front” view of first glove 100, the surfaces of the wrist region 112, palm region 114, and digit regions 118-124 facing the viewer of FIG. 5 are considered to be the “front” surfaces of the wrist region 112, palm region 114, and digit regions 118, 120, 122, and 124, respectively. In particular, the portions of the palm region 114 and digit regions 116, 118, 120, 122, and 124 which comprise the “front” surfaces thereof are those which will contact an object held in the left hand of a person wearing first glove 100. In view of this, the surfaces of the wrist region 112, palm region 114, and digit regions facing the viewer of FIG. 6 may be considered to be the “back” surfaces of the wrist region 112, palm region 114, and digit regions 118-124. Since first glove 100 is a hand-specific glove, the front and back surfaces of thumb region 116 are less obvious to a viewer of FIGS. 5 and 6. The front surface of thumb region 116 will be that surface contacted by an object gripped in the user's hand “H” while wearing first glove 100. The back surface of thumb region 116 is the surface opposite the front surface thereof. It will be understood that the side surfaces of the glove looking in a direction towards thumb region 116 and ultimately towards little finger region 124 may be considered to be the left side surfaces of the wrist region 112, palm region 114, and digit regions 116-124. Similarly, it will be understood that the side surface of the first glove 100 looking in a direction towards little finger region 124 and ultimately towards thumb region 116 may be considered to be the right side surface of the wrist region 112, palm region 114, and digit regions 116-124.

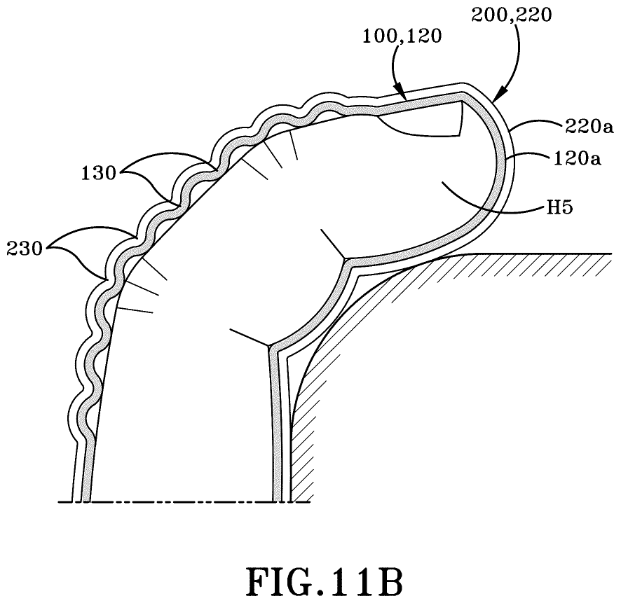

First glove 100 includes a gripping region 126 formed in a back of thumb region 116; a gripping region 128 formed in a back of index finger region 118; a gripping region 130 formed in a back of middle finger region 120; a gripping region 132 formed in a back of ring finger region 122; and a gripping region 134 formed in a back of little finger region 124. As best seen in FIG. 11B, the gripping regions, such as gripping region 130, comprise a plurality of undulations formed in the glove material along the back surface of the associate digit region. The undulations comprises a series of alternating peaks and valleys which extend around a part of the circumference of the associated digit region. In particular, the undulations are oriented at ninety degrees relative to a longitudinal axis of the associated digit region. For example, the undulations of gripping region 130 of middle finger region 120 are oriented at a right angle to longitudinal axis “Y” of middle finger region 120. The undulations of gripping regions 126, 128, 130, 132, and 134 do not extend for more than one half of the circumference of the associated digit region.

The purpose of the undulations of the gripping region 125, 128, 130, 132, and 134 on first glove 100 is that the valleys thereof contact the skin on the back of the person's finger or thumb. The friction resulting from contact between the valleys and the skin tends to resists sliding movement of the glove material along the back of the finger or thumb during use of assembly 10. Furthermore, as the person's finger or thumb is moved from a straight position to a bent position, the amplitude of the undulations decreases slightly and the wavelength between successive valleys increases slightly. This change in the undulations results in the effective length of the back of the associated digit region increasing slightly as the person bends their finger or thumb. The increase in effective length of the backs of the digit regions helps to ensure the first glove 100 is comfortable to wear and that the person's finger dexterity is retained even though first glove 100 is worn.

As best seen in FIG. 5 and FIG. 6, a plurality of undulations is provided in each digit region 116, 118, 120, 122, and 124. The undulations originate a short distance downwardly from the tip 116a, 118a, 120a, 122a, 124a of the associated digit region and terminate a short distance upwardly from the palm region 114. In particular, the plurality of undulations ceases proximate the digit crotches which extend between adjacent digit regions. For example, the gripping regions 128 and 130 terminate proximate the digit crotch 136 (FIG. 6) between index finger region 118 and middle finger region 120.

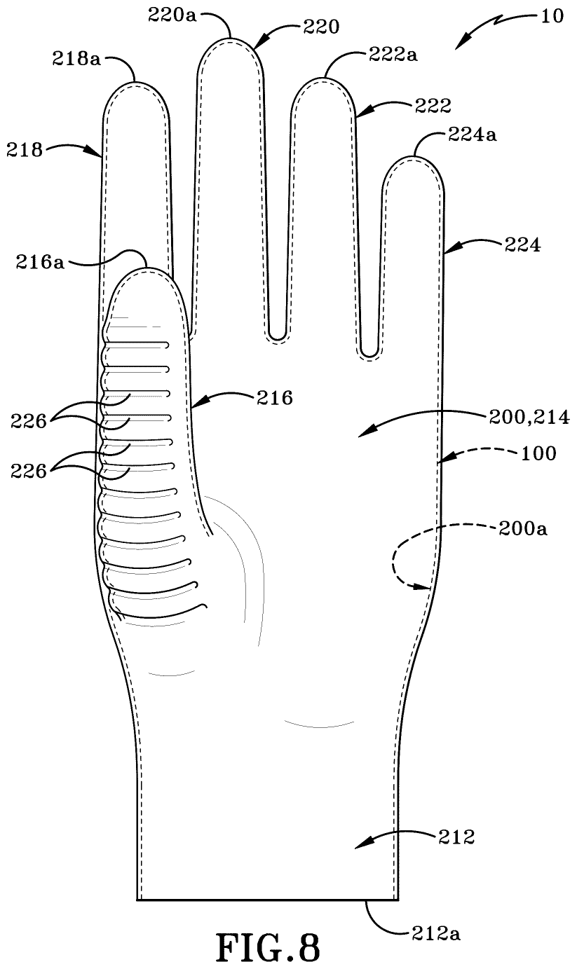

Referring to FIGS. 7 to 9, second glove 200 of assembly 10 is shown in greater detail. Second glove 200 comprises a wrist region 212, a palm region 214, a thumb region 216, an index finger region 218, a middle finger region 220, a ring finger region 222, and a little finger region 224. Thumb region 216, index finger region 218, middle finger region 220, ring finger region 222, and little finger region 224 will be collectively referred to hereinafter as “digit regions”. Wrist region 212, palm region 214, and digit regions 216, 218, 220, 222 224 bound and define a three-dimensional interior cavity configured to receive the hand “H” of the person therein, where the hand “H” is covered by first glove 100. Wrist region 212 defines an opening (not shown) bounded by an end 212a of wrist region 212.

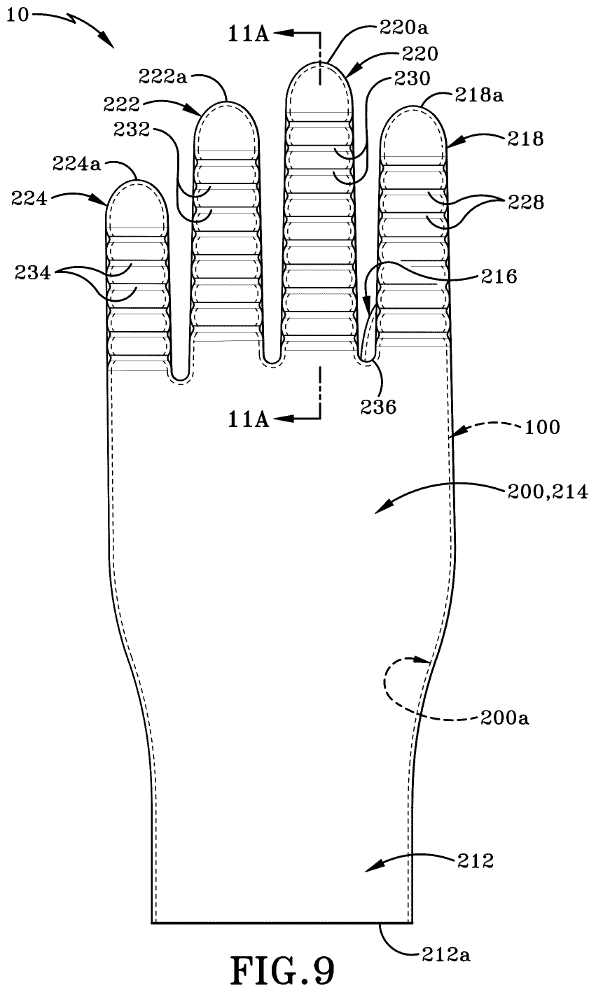

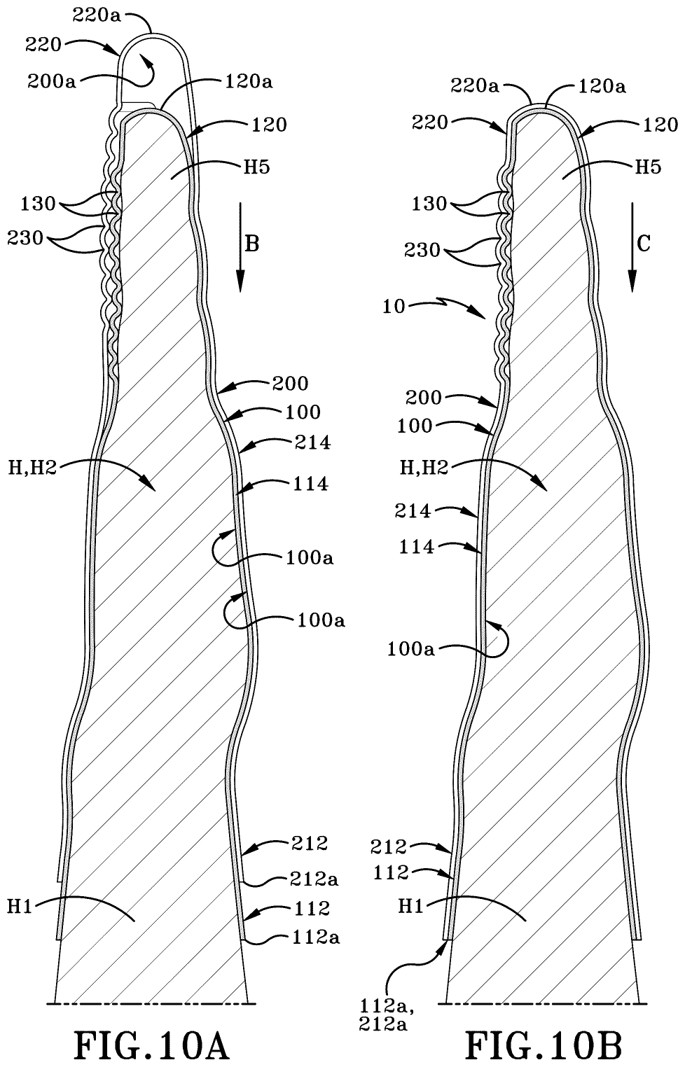

Referring to FIG. 8, the surfaces of second glove 200 facing the viewer of the figure may be considered to form a “front” of the second glove 200. Because FIG. 8 shows a “front” view of second glove 200, the surfaces of the wrist region 212, palm region 214, and digit regions 218-224 facing the viewer of FIG. 8 are considered to be the “front” surfaces of the wrist region 212, palm region 214, and digit regions 218, 220, 222, and 224, respectively. In particular, the portions of the palm region 214 and digit regions 216, 218, 220, 222, and 224 which comprise the “front” surfaces thereof are those which will contact an object held in the left hand of a person wearing second glove 200. In view of this, the surfaces of the wrist region 212, palm region 214, and digit regions facing the viewer of FIG. 9 may be considered to be the “back” surfaces of the wrist region 212, palm region 214, and digit regions 218-224.

Since second glove 200 is a hand-specific glove, the front and back surfaces of thumb region 216 are less obvious to a viewer of FIGS. 8 and 9. The front surface of thumb region 216 will be that surface contacted by an object gripped in the user's hand “H” while wearing second glove 200. The back surface of thumb region 216 is the surface opposite the front surface thereof. It will be understood that the side surfaces of the glove looking in a direction towards thumb region 216 and ultimately towards little finger region 224 may be considered to be the left side surfaces of the wrist region 212, palm region 214, and digit regions 216-224. Similarly, it will be understood that the side surface of the second glove 200 looking in a direction towards little finger region 224 and ultimately towards thumb region 216 may be considered to be the right side surface of the wrist region 212, palm region 214, and digit regions 216-224.

Second glove 200 includes a gripping region 226 formed in a back of thumb region 216; a gripping region 228 formed in a back of index finger region 218; a gripping region 230 formed in a back of middle finger region 220; a gripping region 232 formed in a back of ring finger region 222; and a gripping region 234 formed in a back of little finger region 224. Each gripping region comprises a plurality of undulations formed in the glove material along the back surface of the associate digit region and arranged orthogonal to the longitudinal axis of the associated digit region. The undulations comprises a series of alternating peaks and valleys which extend around a part of the circumference of the associated digit region. The undulations of gripping regions 226, 228, 230, 232, and 234 do not extend for more than one half of the circumference of the associated digit region.

As best seen in FIG. 8 and FIG. 9, the plurality of undulations is formed in each digit region 216, 218, 220, 222, 224 and the undulations originate a short distance downwardly from the tip 216a, 218a, 220a, 222a, 224a of the associated digit region and terminate a short distance upwardly from the palm region 214. In particular, the plurality of undulations cease proximate the digit crotch which extends between adjacent digit regions. For example, the gripping regions 228 and 230 terminate proximate the digit crotch 236 (FIG. 9) between index finger region 218 and middle finger region 220.

Referring to FIGS. 1-3, the donning of assembly 10 is shown diagrammatically. FIG. 1 shows first glove 100 and second glove 200 poised above the hand “H” of the user. In a first step, first glove 100 is moved downwardly towards the hand “H” in the direction indicated by arrow “A”. First glove 100 is moved downwardly until the person is able to insert their hand into the interior cavity 100a of first glove 100 through the opening bounded by end 112a of wrist region 112. In other words, first glove 100 will be pulled onto the user's hand “H” until the user's thumb “H3” in in the portion of the interior cavity 100a defined by thumb region 116; the user's index finger “H4” is received into the portion of the interior cavity 100a defined by index finger region 118; the user's middle finger “H5” is received into the portion of the interior cavity 100a defined by middle finger region 120, and ring finger “H6” is received into the portion of the interior cavity 100a defined by ring finger region 122; and little finger “H7” is received into the portion of the interior cavity 100a defined by little finger region 124. First glove 100 is pulled downwardly in the direction “A” over the person's hand “H” until the tips of the person's fingers and thumb “H3” through “H7” contact the interior surface of first glove 100 proximate the tip 116a-124a of the associated digit region 116 through 124.

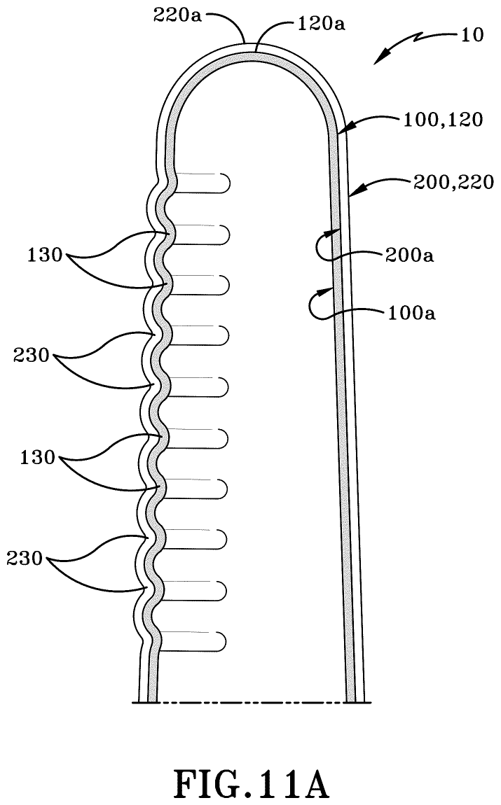

FIG. 10A shows the person's hand “H” fully covered by first glove 100 (such that the tip of the person's middle finger “H5” contacts the interior surface of the tip 120a of middle finger region 120.

In a second step, second glove 200 is moved downwardly in the direction indicated by arrow “B” towards the person's hand “H” which is now covered by first glove 100. Second glove 200 is moved downwardly in the direction “B” until the gloved tips of the person's thumb and fingers enter into the interior cavity 200a of second glove 200 through the opening bounded by end 212a of wrist region 212 of second glove 200.

FIG. 10A further illustrates the second glove 200 being moved downwardly in the direction “B” over the exterior surface of first glove 100. The figure shows that initially, the tip 120a of first glove 120 does not contact the interior surface of the tip 220a of middle finger region 220 of second glove 220. Additionally, the plurality of undulations of the gripping region 230 of second glove 200 are not fully aligned with the plurality of undulations of the gripping region 130 of first glove 100.

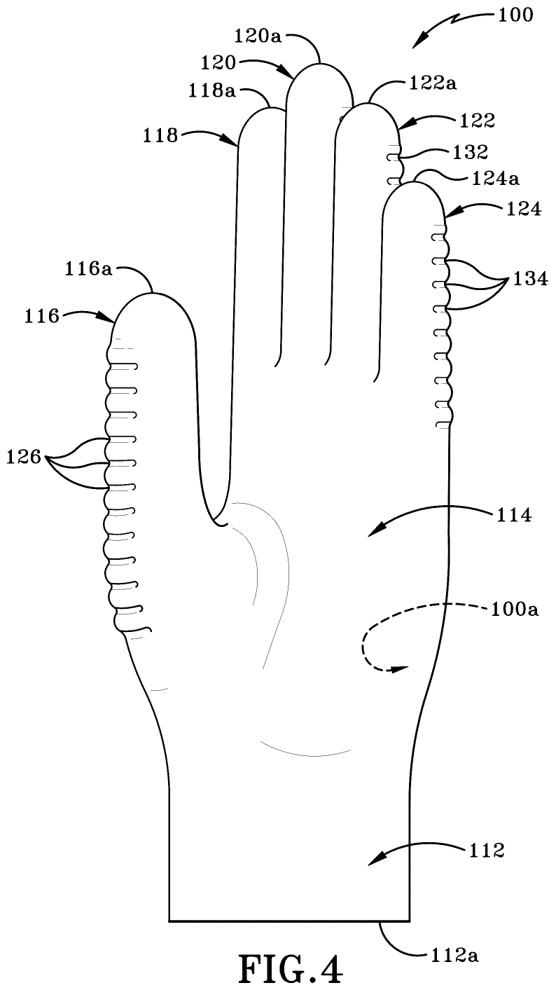

FIGS. 3 and 10B show second glove 200 is pulled downwardly, as indicated by arrow “C” until the tip 120a of first glove 120 contacts the interior surface of the tip 220a of middle finger region 220 of second glove 200, and until the plurality of undulations of gripping region 230 of second glove 200 are fully aligned with the plurality of undulations of gripping region 130 of first glove 100. When second glove 200 is pulled downwardly in the direction “C” to fully nest with first glove 100, the tips 116a-124a of the digit regions 116-124 of first glove 100 will nest within the interior surfaces of the tips 216a-224a of the digit regions of second glove 200. Additionally, the digit crotches of second glove 200 will nest with the associated digit crotches of the first glove 100. For example, the digit crotch 236 (FIG. 9) will nest with the digit crotch 136 (FIG. 6) of first glove 100. Still further, the end 212a of wrist region 212 of second glove 200 will align with the end 112a of wrist region 112 of first glove 100. Because of this nesting alignment of the various components of first glove 100 and second glove 200, assembly 10 will move as a unitary glove on the person's hand “H”. In other words, the outer second glove 200 will not slip relative to first glove 100, nor will second glove 200 bunch up at the tips 216a to 224a of the digit regions and thereby negatively affect the finger dexterity or tactile sensitivity of the person wearing the assembly 10.

FIGS. 11A and 11B show that assembly 10 will move in unison as the digit regions, such as middle finger region 120, move between a straight position (FIG. 11A) and a bent position (FIG. 11B). These figures also show there is close conformity between an interior surface of second glove 200 which defines interior cavity 200a and an exterior surface of first glove 100. In other words, there is direct contact between the interior surface of second glove 200 and the exterior surface of first glove 100. Stated differently, there are substantially no air pockets between the interior surface of second glove 200 and the exterior surface of first glove 100. There is also close conformity between the person's middle finger “H5” and the interior surface of first glove 100. This close conformity, i.e., direct contact between hand “H” and first glove 100, and between first glove 100 and second glove 200, helps the person wearing the glove to be able to maintain tactile sensitivity of their hand “H” and to readily and easily manipulate objects held in the hand.

Additionally, the assembly 10 provides the additional feature of a double layer of protection for the user against cut's or piercing by sharp implements (such as scalpels and needles), and against bodily fluids, pathogens, and chemicals.

It will be understood that since first glove 100 and second glove 200 are identical, it is irrelevant whether first glove 100 is donned first and second glove 200 is pulled onto the hand “H” over first glove 100; or if second glove 200 is donned first and first glove 100 is pulled onto the hand “H” over second glove 200.

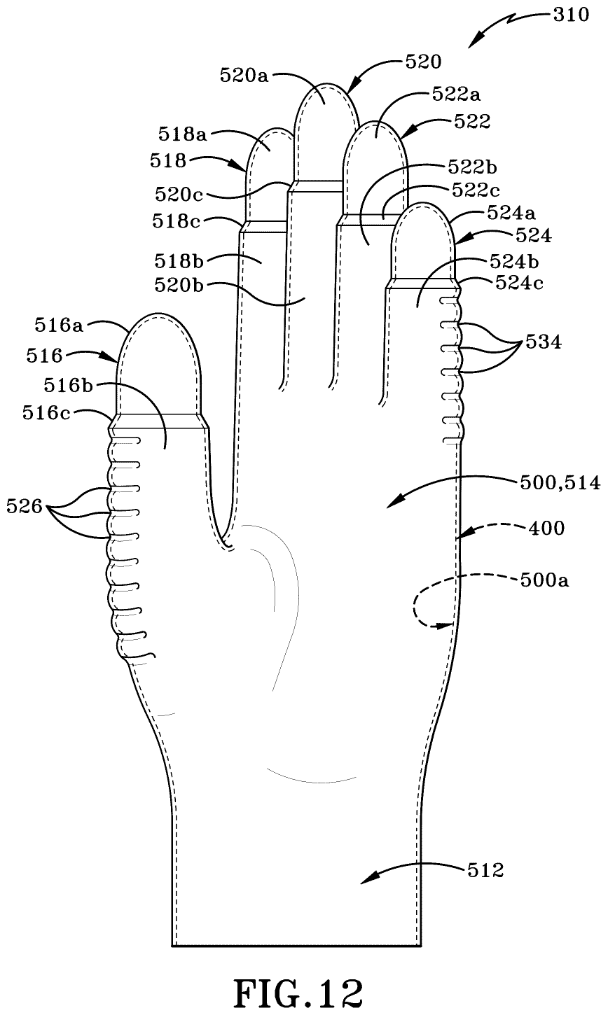

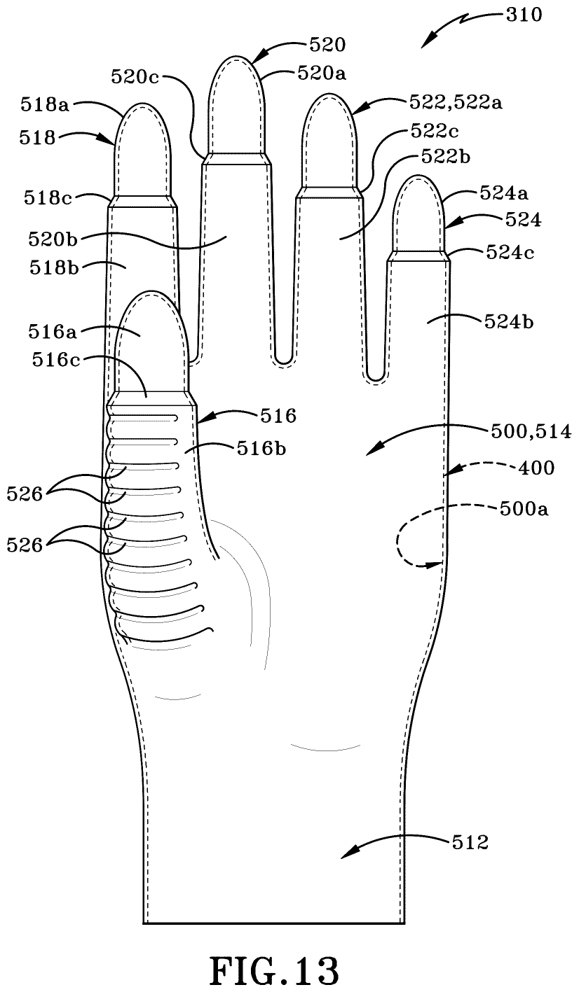

Referring now to FIGS. 12-15 there is shown a second embodiment of a double glove assembly, generally indicated herein as assembly 310. Assembly 310 comprises a first glove 400 and a second glove 500. It will be understood that like assembly 10, the first glove 400 and second glove 500 of assembly 310 are configured to be pulled onto a user's hand “H” in a substantially identical manner to the manner shown in FIGS. 1 to 3 regarding the first glove 100 and second glove 200 of assembly 10.

Gloves 400 and 500 are substantially identical in structure, function, and use to one another and to gloves 100 and 200 except for the features which will be described hereafter. Because first and second gloves 400, 500 are substantially identical to first and second gloves 100, 200, first and second gloves 400, 500 will not be described herein in any particular detail hereafter. It should be understood that the description of first glove 100 and second glove 200 applies equally to first glove 400 and second glove 500.

First glove 400 and second glove 500 differ from first glove 100 and second glove 200, respectively, in that the digit regions in first glove 400 and second glove 500 include reduced circumference fingertip regions. Second glove 500 will be described hereafter in some detail but it will be understood that the description applies equally to first glove 400 which is identically configured to second glove 500.

Second glove 500 comprises a wrist region 512, a palm region 514, a thumb region 516, an index finger region 518, a middle finger region 520, a ring finger region 522, and a little finger region 524. Thumb region 516, index finger region 518, middle finger region 520, ring finger region 522, and little finger region 524 will be collectively referred to hereinafter as “digit regions”. Wrist region 512, palm region 514, and digit regions 516, 518, 520, 522, 524 bound and define a three-dimensional interior cavity 500a (FIG. 12) configured to receive the hand “H” of the person therein, which hand will be already covered by first glove 400.

Second glove 500 differs from second glove 200 in that each of the digit regions 516, 518, 520, 522, 524 includes a fingertip region of a reduced circumference relative to a remaining portion of the associated digit region. In accordance with an aspect of the third embodiment second glove 500, a transition region extends between the fingertip region and the remaining portion of each digit region. The transition region tapers in circumference from the remaining portion of the associated digit region to the reduced circumference of the fingertip region. As illustrated, the fingertip region provided on each digit region is of a bullet-tip shape. Thumb region 516 includes a fingertip region 516a, a remaining portion 516b, and a transition region 516c. Index finger region 518 includes a fingertip region 518a, a remaining portion 518b, and a transition region 518c. Middle finger region 520 includes a fingertip region 520a, a remaining portion 520b, and a transition region 520c. Ring finger region 522 includes a fingertip region 522a, a remaining portion 522b, and a transition region 522c. Finally, little finger region 524 includes a fingertip region 524a, a remaining portion 524b, and a transition region 524c. The reduced circumference of the fingertip regions 516a, 518a, 520a, 522a, and 524a ensures that second glove 500 closely conforms to the fingertips of the person's hand and thereby helps to ensure the person's tactile sensitivity and finger and thumb dexterity is maintained even while second glove 500 is worn.

The provision of the reduced circumference fingertip regions and transitions regions on the digit regions of second glove 500 is in contrast to the substantially constant circumference digit regions of second glove 200. The second glove 200 has digit regions which very gradually taper in circumference.

Second glove 500 includes a gripping region 526 formed in a back of thumb region 516; a gripping region 528 formed in a back of index finger region 518; a gripping region 530 formed in a back of middle finger region 520; a gripping region 532 formed in a back of ring finger region 522; and a gripping region 534 formed in a back of little finger region 524. Each gripping region comprises a plurality of undulations formed in the glove material along the back surface of the associate digit region and arranged orthogonal to the longitudinal axis of the associated digit region. The undulations comprises a series of alternating peaks and valleys which extend around a part of the circumference of the associated digit region. The undulations of gripping regions 526, 528, 530, 532, and 534 do not extend for more than one half of the circumference of the associated digit region.

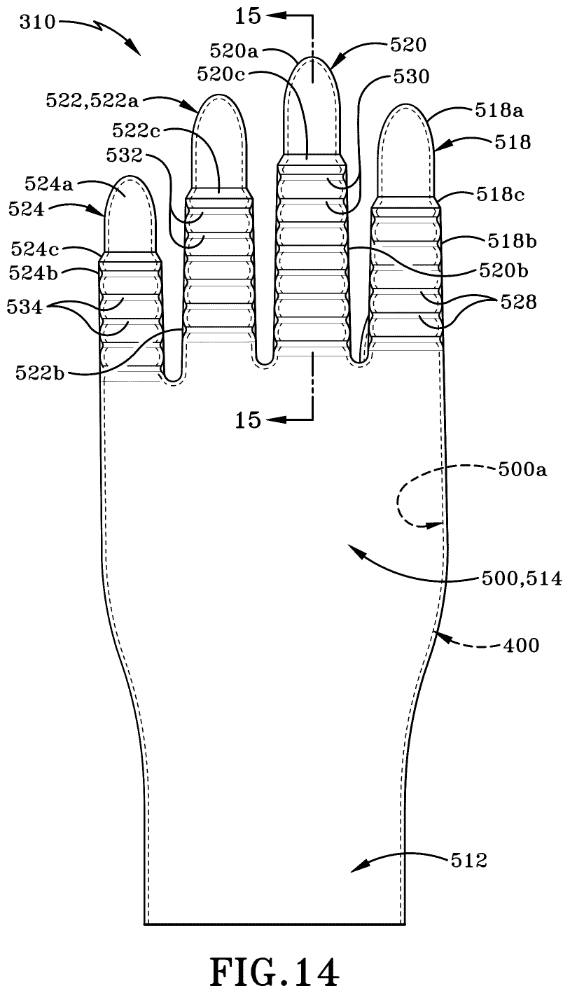

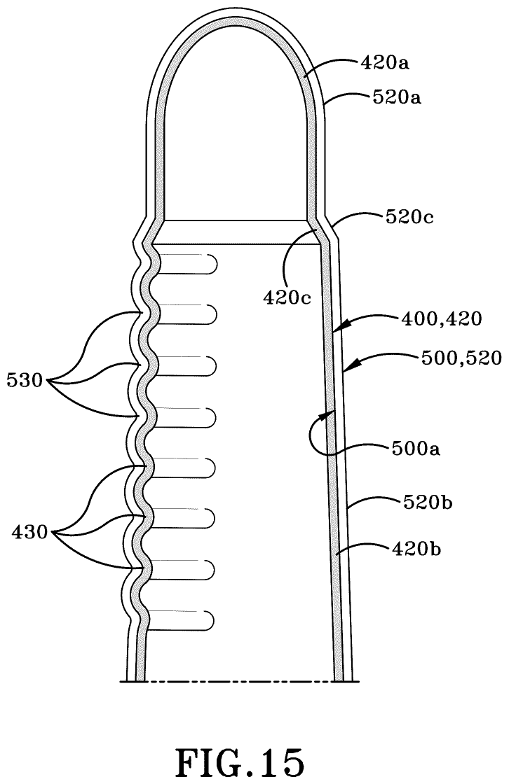

FIGS. 14 and 15 show that the undulations of gripping regions 526, 528, 530, 532, and 534 in second glove 500 originate just below the transition region 516c, 518c, 520c, 522c, 524c of the associated digit region. Additionally, these figures show that the transition region and the fingertip region of each associated digit region is free of any undulations. It will be understood, however, that in other embodiments one or both of the transition region and fingertip region of the associated digit region may include undulations therein.

FIG. 16 shows a cross section through the middle finger region of the assembly 310. The figure shows the middle finger region 420 of first glove 400 and the middle finger region 520 of second glove 500. The middle finger region 420 and middle finger region 520 are fully nested with one another. In other words, FIG. 16 shows an enlarged partial view similar to FIG. 10B with the person's middle finger removed or FIG. 11A. Fingertip regions 420a, 520a are fully nested with one another. Transition regions 420c, 520c are fully nested with one another. Additionally, the remaining portions 420b, 520b are fully nested with one another. Still further, the undulations of gripping region 530 are fully nested with the undulations of gripping region 430. FIG. 16 shows that the exterior surface of the middle finger region 420 of first glove 400 is in close abutting contact with the interior surface of the middle finger region 520 of second glove 500. It will be understood that the rest of first glove 400 and second glove 500 are in close conformity with one another such that the two gloves 400, 500 which comprise assembly 310 will move in unison.

First glove 100 and second glove 200 (and first glove 400 and second glove 500) have been described herein as being identical in configuration, i.e., in physical construction and in the glove materials used to fabricate the same. In other embodiments, the physical construction of the first glove 100 and second glove 200 may be identical so that the gloves 100, 200 will nest fully within one another. However, the glove material used to fabricate the first glove 100 may differ from the glove material used to fabricate the second glove 200. For example, the first glove 100 which will contact the person's hand may be fabricated from a nitrile which is free of or essentially free of zinc and/or sulfur and/or accelerators/accelerants and is therefore suitable for contacting the person's skin as the glove material is less likely to cause allergic reaction in the person's skin. The second glove 200 which will be separated from the person's skin by first glove 100 may be fabricated from a glove material which is resistant to opioids, substances mixed with opioids, bodily fluids, and toxic or corrosive chemicals. Still further, the outer glove, i.e., second glove 200, may include materials which improve the cut resistance or pierce resistance of the second glove 200. Additionally, one or both of the first glove 100 and the second glove 200 may be fabricated so an outer layer is a first color and an inner layer is a second color which contrasts with the first color. Then when the first glove 100 and second glove 200 are worn on the same hand and the person accidentally cuts or pierces the second glove 200 and possibly the first glove 100, the color of the inner layer will become visible on an exterior surface of the second glove and make the person aware that the second glove 200 and possibly the first glove 100 have been compromised and must be removed from the hand and replaced with a new assembly 10 (or 310).

A method of protecting a person's hand “H” utilizing glove assembly 10 or glove assembly 310 comprises providing a first glove 100 or 400 and a second glove 200 or 500. The first gloves 100, 400 and second gloves 200, 500 are substantially identical in physical configuration, i.e., of the same shape and size and including substantially identical profile features. The term “profile features” is used herein to collectively encompass the features of the overall shape and size of the wrist regions, palm regions, thumb regions, index finger regions, middle finger regions, ring finger regions, and little finger regions of the gloves 100, 200, 400, 500. The term “profile features” also encompasses physical components of the gloves such as the gripping regions, fingertip regions, transition regions, and remaining portions thereof. So, for example, some of first profile features of first glove 100 are the gripping regions 126, 128, 130, 132, and 134. The second glove 200 has complementary second profile features in the form of the gripping regions 226, 228, 230, 232, and 234. Some of the second profile features of the second glove 500 are the fingertip regions 116a, 118a, 120a, 122a, 124a; the remaining portions 116b, 118b, 120b, 122b, 124b; and the transition portions 116c, 118c, 120c, 122c, 124b. Additional second profile features on second glove 500 include the gripping regions 526, 528, 530, 532, and 534. These second profile features of second glove 500 are complementary to first profile features on first glove 400 in the form of complementary gripping regions, fingertip regions, remaining portions, transition portions.

The method in accordance with the present disclosure includes pulling the first glove 100 or 400 over the hand “H” of the person and then pulling the second glove 200 or 500 over the same hand “H” of the person while their hand “H” is covered with the first glove 100 or 400. The method further includes nesting an exterior surface of the first glove 100 or 400 within an interior surface of the second glove 200 or 500. The nesting further includes nesting a first profile feature of the first glove 100 or 400 within a second profile feature of the second glove 200 or 500.

The method in accordance with the present disclosure further includes forming the first glove 100 or 400 from a first glove material, and forming the second glove 200 and 500 from a second glove material which is different from the first glove material. As described earlier herein, the second glove material may be one that is opioid resistant and the first glove material may be one that reduces the possibility of allergic reaction in the skin of the person using the assembly 10 or 310.

Various inventive concepts may be embodied as one or more methods, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

While various inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize, or be able to ascertain using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

All definitions, as defined and used herein, should be understood to control over dictionary definitions, definitions in documents incorporated by reference, and/or ordinary meanings of the defined terms.

The articles “a” and “an,” as used herein in the specification and in the claims, unless clearly indicated to the contrary, should be understood to mean “at least one.” The phrase “and/or,” as used herein in the specification and in the claims (if at all), should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc. As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

While components of the present disclosure are described herein in relation to each other, it is possible for one of the components disclosed herein to include inventive subject matter, if claimed alone or used alone. In keeping with the above example, if the disclosed embodiments teach the features of A and B, then there may be inventive subject matter in the combination of A and B, A alone, or B alone, unless otherwise stated herein.

As used herein in the specification and in the claims, the term “effecting” or a phrase or claim element beginning with the term “effecting” should be understood to mean to cause something to happen or to bring something about. For example, effecting an event to occur may be caused by actions of a first party even though a second party actually performed the event or had the event occur to the second party. Stated otherwise, effecting refers to one party giving another party the tools, objects, or resources to cause an event to occur. Thus, in this example a claim element of “effecting an event to occur” would mean that a first party is giving a second party the tools or resources needed for the second party to perform the event, however the affirmative single action is the responsibility of the first party to provide the tools or resources to cause said event to occur.

When a feature or element is herein referred to as being “on” another feature or element, it can be directly on the other feature or element or intervening features and/or elements may also be present. In contrast, when a feature or element is referred to as being “directly on” another feature or element, there are no intervening features or elements present. It will also be understood that, when a feature or element is referred to as being “connected”, “attached” or “coupled” to another feature or element, it can be directly connected, attached or coupled to the other feature or element or intervening features or elements may be present. In contrast, when a feature or element is referred to as being “directly connected”, “directly attached” or “directly coupled” to another feature or element, there are no intervening features or elements present. Although described or shown with respect to one embodiment, the features and elements so described or shown can apply to other embodiments. It will also be appreciated by those of skill in the art that references to a structure or feature that is disposed “adjacent” another feature may have portions that overlap or underlie the adjacent feature.

Spatially relative terms, such as “under”, “below”, “lower”, “over”, “upper”, “above”, “behind”, “in front of”, and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if a device in the figures is inverted, elements described as “under” or “beneath” other elements or features would then be oriented “over” the other elements or features. Thus, the exemplary term “under” can encompass both an orientation of over and under. The device may be otherwise oriented (rotated 90 degrees or at other orientations) and the spatially relative descriptors used herein interpreted accordingly. Similarly, the terms “upwardly”, “downwardly”, “vertical”, “horizontal”, “lateral”, “transverse”, “longitudinal”, and the like are used herein for the purpose of explanation only unless specifically indicated otherwise.

Although the terms “first” and “second” may be used herein to describe various features/elements, these features/elements should not be limited by these terms, unless the context indicates otherwise. These terms may be used to distinguish one feature/element from another feature/element. Thus, a first feature/element discussed herein could be termed a second feature/element, and similarly, a second feature/element discussed herein could be termed a first feature/element without departing from the teachings of the present invention.

An embodiment is an implementation or example of the present disclosure. Reference in the specification to “an embodiment,” “one embodiment,” “some embodiments,” “one particular embodiment,” “an exemplary embodiment,” or “other embodiments,” or the like, means that a particular feature, structure, or characteristic described in connection with the embodiments is included in at least some embodiments, but not necessarily all embodiments, of the invention. The various appearances “an embodiment,” “one embodiment,” “some embodiments,” “one particular embodiment,” “an exemplary embodiment,” or “other embodiments,” or the like, are not necessarily all referring to the same embodiments.

If this specification states a component, feature, structure, or characteristic “may”, “might”, or “could” be included, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

As used herein in the specification and claims, including as used in the examples and unless otherwise expressly specified, all numbers may be read as if prefaced by the word “about” or “approximately,” even if the term does not expressly appear. The phrase “about” or “approximately” may be used when describing magnitude and/or position to indicate that the value and/or position described is within a reasonable expected range of values and/or positions. For example, a numeric value may have a value that is +/−0.1% of the stated value (or range of values), +/−1% of the stated value (or range of values), +/−2% of the stated value (or range of values), +/−5% of the stated value (or range of values), +/−10% of the stated value (or range of values), etc. Any numerical range recited herein is intended to include all sub-ranges subsumed therein.

Additionally, the method of performing the present disclosure may occur in a sequence different than those described herein. Accordingly, no sequence of the method should be read as a limitation unless explicitly stated. It is recognizable that performing some of the steps of the method in a different order could achieve a similar result.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively.

To the extent that the present disclosure has utilized the term “invention” in various titles or sections of this specification, this term was included as required by the formatting requirements of word document submissions pursuant the guidelines/requirements of the United States Patent and Trademark Office and shall not, in any manner, be considered a disavowal of any subject matter.

In the foregoing description, certain terms have been used for brevity, clearness, and understanding. No unnecessary limitations are to be implied therefrom beyond the requirement of the prior art because such terms are used for descriptive purposes and are intended to be broadly construed.

Moreover, the description and illustration of various embodiments of the disclosure are examples and the disclosure is not limited to the exact details shown or described.

What is claimed is:

1. A glove assembly comprising:
a first glove and a second glove;
wherein each of the first glove and the second glove includes a plurality of digit regions;
a first gripping region provided on a back of at least one digit region of the plurality of digit regions of the first glove;
a second gripping region provided on a back of at least one digit region of the plurality of digit regions of the second glove; wherein the second gripping region is complementary to the first gripping region;
wherein the first glove defines an interior cavity adapted to receive a hand of a person therein;
wherein the second glove defines an interior cavity;
wherein the first glove is received within the interior cavity of the second glove; and
wherein the first gripping region nests within the second gripping region when the first glove is received within the interior cavity of the second glove.

2. The glove assembly according to claim 1, wherein the first gripping region comprises a plurality of undulations formed in the back surface of the one or more digit regions of the first glove, and the second gripping regions comprises a plurality of undulations formed in the back surface of the one or more digit regions of the second glove.

3. The glove assembly according to claim 2, wherein the plurality of undulations in each of the first glove and the second glove comprises a plurality of alternating peaks and valleys.

4. The glove assembly according to claim 3, wherein the peaks of the plurality of undulations in the first glove nest with the peaks of the plurality of undulations in the second glove and wherein the valleys of the plurality of undulations in the first glove nest with the valleys of the plurality of undulations in the second glove.

5. The glove assembly according to claim 1, wherein each of the first gripping region and the second gripping region originates a distance inwardly from a tip of a digit region of a respective one of the first glove and the second glove.

6. The glove assembly according to claim 1, wherein each of the first gripping region and the second gripping region terminates a distance outwardly from a digit crotch of the respective one of the first glove and the second glove, wherein the digit crotch extends between two adjacent digit regions on the respective one of the first glove and the second glove.

7. The glove assembly according to claim 1, further comprising:
a third glove and a fourth glove configured to be worn on an opposite hand of the person from the hand upon which the first glove and the second glove are worn; and
wherein the third glove and fourth glove are identical to one another and are configured as mirror images of the first glove and the second glove.

8. The glove assembly according to claim 1, wherein each of the first glove and the second glove includes:
a wrist region;
a palm region extending outwardly from the wrist region;
wherein the plurality of digit regions extend outwardly from a portion of the palm region opposite the wrist region; and
wherein the wrist region, the palm region, and the plurality of digit regions together defines the interior cavity of a respective one of the first glove and the second glove.

9. The glove assembly according to claim 8, wherein the wrist region, the palm region, and the plurality of digit regions are fabricated from a glove material which is resistant to one or more of opioids, substances mixed with opioids, bodily fluids, and toxic or corrosive chemicals.

10. The glove assembly according to claim 8, wherein the wrist region, the palm region, and the plurality of digit regions are fabricated such that the interior surface of each of the first glove and the second glove is of a first color and the exterior surface of each of the first glove and the second glove is of a second color, and the first color contrasts with the second color.

11. The glove assembly according to claim 10, wherein providing the interior surface of the first color and the exterior surface of the second color acts as a wear or cut indicator.

12. The glove assembly according to claim 1, wherein the one or more digit regions of the plurality of digit regions includes a fingertip region and a remaining portion, wherein the fingertip region is of a reduced circumference relative to a circumference of the remaining portion thereof.

13. The glove assembly according to claim 12, further comprising a transition portion extending between the fingertip region and the remaining portion, wherein the transition regions tapers in circumference moving in a direction away from the palm region and towards a tip of the one or more digit regions.

14. The glove assembly according to claim 13, wherein the fingertip region, the transition portion, and the remaining portion of the one or more digit regions of the first glove nest within the fingertip region, the transition portion, and the remaining portion of the one or more digit regions of the second glove.

15. The glove assembly according to claim 14, wherein the plurality of undulations originate and terminate in the remaining portion of the one or more digit regions, and wherein the plurality of undulations in the first glove nest within the plurality of undulations in the second glove.

16. (canceled)

17. (canceled)

18. (canceled)

19. (canceled)

20. (canceled)

21. The glove assembly according to claim 1, wherein the first glove is a hand-specific glove and wherein the second glove is a hand-specific glove for the same hand as the first glove.

22. The glove assembly according to claim 2, wherein the undulations extend to a length of one half or less of the circumference of the digit region where the undulations are present.

23. The glove assembly according to claim 2, wherein the undulations start a distance downwardly from the fingertip region and extend through the digit region, wherein the undulations terminate a distance upwardly from the palm region.

24. The glove assembly according to claim 7, wherein the third glove is a hand-specific glove and wherein the fourth glove is a hand-specific glove for the same hand as the third glove.

25. The glove assembly according to claim 1, wherein the material used to fabricate the first glove may differ from the material used to fabricate the second glove.
